(19) United States
(12) Patent Application Publication
(10) Pub. No.: US 2019/0224845 A1
(43) Pub. Date: Jul. 25, 2019

(54) METHOD FOR CONTROLLING ROBOT AND CONTROLLER OF ROBOT

(71) Applicant: Fanuc Corporation, Yamanashi (JP)

(72) Inventor: Masahide SHINAGAWA, Yamanashi (JP)

(73) Assignee: Fanuc Corporation, Yamanashi (JP)

(21) Appl. No.: 16/246,176

(22) Filed: Jan. 11, 2019

(30) Foreign Application Priority Data
Jan. 22, 2018 (JP) 2018-007822

(51) Int. Cl. B25J 9/16

(52) U.S. Cl. CPC B25J 9/1623; B25J 9/1664; B25J 9/1633

(57) ABSTRACT

Provided is a method for controlling a robot including plural articulated shafts capable of moving a workpiece in a same direction while supporting the workpiece. In moving the workpiece by the robot, the method controls each of the articulated shafts in such a way that an interference torque caused by acceleration or deceleration of one articulated shaft and acting on another articulated shaft and a torque for accelerating or decelerating the other articulated shaft do not act in opposite directions simultaneously.

### CROSS-REFERENCE TO RELATED APPLICATIONS

This application claims the benefit of Japanese Patent Application No. 2018-007822, the content of which is incorporated herein by reference.

### TECHNICAL FIELD

The present invention relates to a method for controlling a robot and a controller of the robot.

### BACKGROUND ART

A seven-axis robot conventionally has been known that includes a robot main body having six articulated rotary shafts, and an articulated slide shaft added to a distal end of a wrist of the robot main body to linearly move a workpiece in one direction (for example, see PTL 1). The objectives of the seven-axis robot are to speed up the transfer of the workpiece between pressing apparatuses and also to allow for a greater transfer range.

The robot disclosed in PTL 1 requires acceleration or deceleration of the articulated rotary shafts of the robot main body and the articulated slide shaft, in order to synchronize them with operations of two pressing apparatuses after the workpiece is transferred to or from one of the pressing apparatuses, or when the workpiece is transferred from or to the other of the pressing apparatuses.

In other words, the robot disclosed in PTL 1 has multiple articulated shafts, which move the workpiece in the same direction, accelerated or decelerated simultaneously in the same direction during operations in which a transfer tool is withdrawn from one of the pressing apparatuses to stand by between the pressing apparatuses and then inserted into the other of the pressing apparatuses in synchronization with an operation of the other of the pressing apparatuses.

### CITATION LIST

### Patent Literature

{PTL 1} U.S. Unexamined Patent Application, Publication No. 2012/239184

### SUMMARY OF INVENTION

According to an aspect of the present invention, there is provided a method for controlling a robot having a plurality of articulated shafts capable of moving a workpiece in the same direction while supporting the workpiece. The method includes, in moving the workpiece by the robot, controlling each of the articulated shafts in such a way that an interference torque caused by acceleration or deceleration of one of the articulated shafts and acting on another one of the articulated shafts and a torque for accelerating or decelerating the other one of the articulated shafts do not act in opposite directions simultaneously.

According to another aspect of the present invention, there is provided a controller of a robot having a plurality of articulated shafts capable of moving a workpiece in the same direction while supporting the workpiece. In response to input of an operation program to move the workpiece by the robot, the controller sets acceleration of one and another of the articulated shafts in such a way that the other one of the articulated shafts is accelerated or decelerated in the same direction as a direction of an interference torque caused by acceleration or deceleration of the one of the articulated shafts and acting on the other one of the articulated shafts.

### BRIEF DESCRIPTION OF DRAWINGS

FIG. 1 is a perspective view of an example of a robot controlled by a controlling method according to an embodiment of the present invention.

FIG. 2 is a perspective view of a transfer tool provided to the robot of FIG. 1, as viewed from a wrist-side slider.

FIG. 3 is a perspective view of the transfer tool of FIG. 2, as viewed from a workpiece-side slider.

FIG. 4 is a front view of a distal swing shaft provided to the workpiece-side slider of the transfer tool of FIG. 2.

FIG. 5 is a partially broken-away plan view of the distal swing shaft of FIG. 4.

FIG. 6 is a perspective view illustrating supply and removal of the workpiece to/from pressing apparatuses by the robot of FIG. 1.

FIG. 7 is a perspective view of an example of a tool attached to the transfer tool of FIG. 2.

FIG. 8 is a perspective view of an example of an interface portion provided to each end of a shaft constituting the distal swing shaft of the transfer tool of FIG. 2.

FIG. 9 is a perspective view of another example of the interface portion of FIG. 8.

FIG. 10 is a schematic view illustrating a state S1 of operations of the robot of FIG. 1 in relation to the pressing apparatuses.

FIG. 11 is a schematic view illustrating a state S2 of the operations of the robot of FIG. 1 in relation to the pressing apparatuses.

FIG. 12 is a schematic view illustrating a state S3 of the operations of the robot of FIG. 1 in relation to the pressing apparatuses.

FIG. 13 is a schematic view illustrating acceleration of a seventh shaft alone from the state S1 of FIG. 10.

FIG. 14 is a schematic view illustrating acceleration of a first shaft and deceleration of the seventh shaft from the state of FIG. 13.

FIG. 15 is a schematic view illustrating re-acceleration of the seventh shaft and deceleration of the first shaft from the state of FIG. 14 to result in the state S2 of FIG. 11.

FIG. 16 is a schematic view illustrating re-acceleration of the first shaft and deceleration of the seventh shaft from the state of FIG. 15.

FIG. 17 is a schematic view illustrating halt of the seventh shaft and deceleration of the first shaft from the state of FIG. 16 to result in the state S3 of FIG. 13.

FIG. 18 is a timing chart illustrating changes in torque during the operations of FIGS. 13 to 17.

FIG. 19 is a block diagram of a controller of a robot according to an embodiment of the present invention.

### DESCRIPTION OF EMBODIMENTS

Hereinafter, a method for controlling a robot 100 and a controller 60 of the robot 100 according to an embodiment of the present invention will be explained with reference to the drawings.

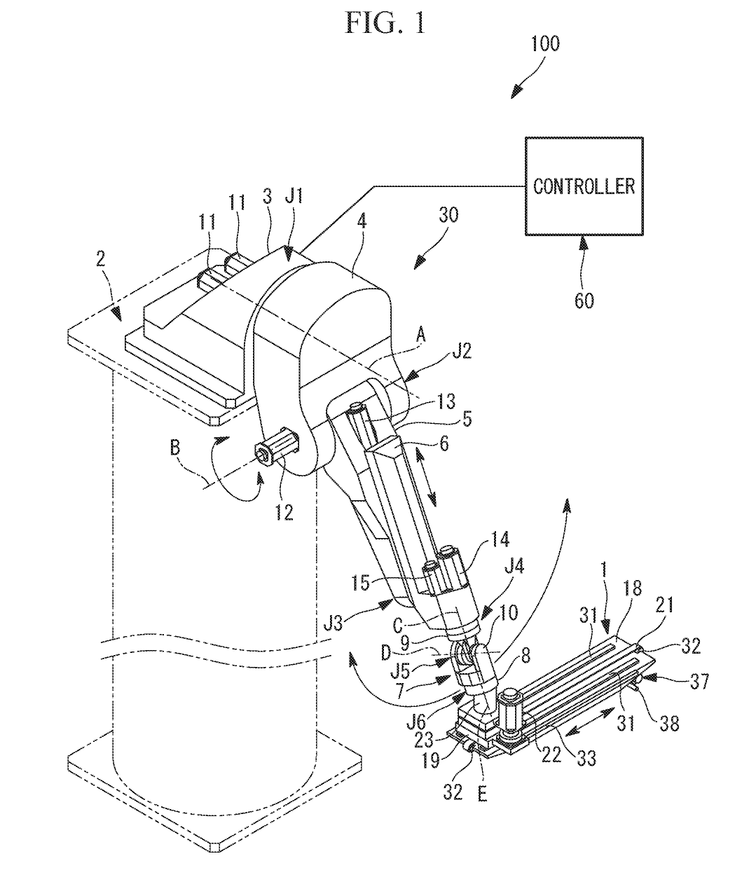

As shown in FIG. 1, the robot 100 controlled by the controlling method and the controller 60 according to the present embodiment includes a multi-articulated type robot main body 30, and a slide arm type transfer tool (articulated shaft) 1 attached to a distal end of a wrist of the robot main body 30.

As shown in FIG. 1, the robot main body 30 includes, for example: a base 3 fixed to a support stand 2; a swing base 4 supported on one side surface of the base 3 so as to be rotatable around a horizontal first axis A; a first arm 5 supported so as to be swingable around a second axis B that is perpendicular to an axis (not shown in the figure) spatially parallel to the first axis A; a second arm 6 supported so as to be linearly movable in a longitudinal direction of the first arm 5; and a wrist unit (wrist) 7 disposed at a distal end of the second arm 6.

That is, the robot main body 30 includes: a first shaft (articulated shaft) J1 that rotates the swing base 4 around the first axis A and relative to the base 3; a second shaft (articulated shaft) J2 that swings the first arm 5 around the second axis B and relative to the swing base 4; and a third shaft (articulated shaft) J3 that linearly moves the second arm 6 in the longitudinal direction of the first arm 5 and relative to the first arm 5.

The wrist unit 7 may include two or more rotary shafts that rotate around mutually intersecting axes C, D and E.

The wrist unit 7 includes three rotary shafts (a fourth shaft (articulated shaft) J4, a fifth shaft (articulated shaft) J5 and a sixth shaft (articulated shaft) J6) respectively rotating around the mutually intersecting axes C, D and E. The sixth shaft J6, which is distal, is provided with a face plate 8 for fixing a tool and the like. The fourth shaft J4 rotates a first wrist housing 9 relative to the second arm 6 and around the fourth axis C that is parallel to the longitudinal direction of the first arm 5. The fifth shaft J5 rotates a second wrist housing 10 around the fifth axis D that is perpendicular to the fourth axis C. The sixth shaft J6 rotates the face plate 8 around the sixth axis E that is perpendicular to the fifth axis D. In the figures, the reference numerals 11 to 16 denote respective motors for the first shaft J1 to the sixth shaft J6.

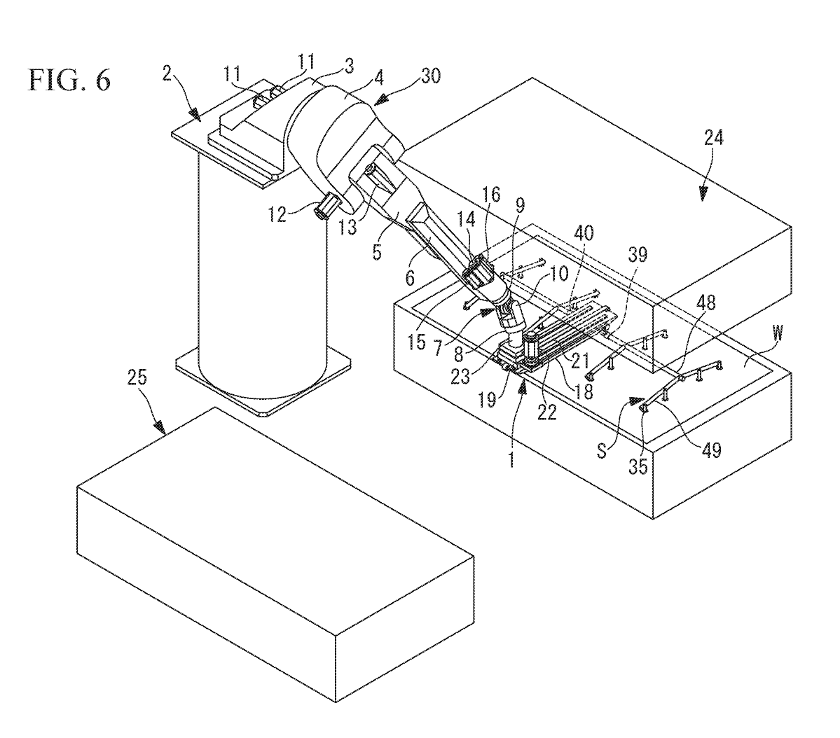

Since the first shaft J1 rotates the swing base 4 around the horizontal first axis A, the first shaft J1 swings, like a pendulum, the swing base 4 and the components attached to the swing base 4 including the first arm 5, the wrist unit 7 and other intermediate components. The movement range of this pendulum-like swing is set so as not to reach a substantially horizontal plane including the first axis A. When a workpiece W (see FIG. 6) is transferred by this pendulum-like swing, gravity always acts in a direction that helps acceleration or deceleration, and this allows for a rapid and energy-efficient swing operation by the first shaft J1.

The second shaft J2 is capable of changing an inclination of the first arm 5 relative to the swing base 4. The third shaft J3 is capable of lengthening or shortening a length of an entire arm, which consists of the first arm 5 and the second arm 6, by linearly moving the second arm 6 relative to the first arm 5.

That is, the wrist unit 7 may be positioned at any position within the movement range by the first shaft J1 to the third shaft J3. Further, the transfer tool 1, which is attached to the face plate 8, may be disposed at any orientation by the fourth shaft J4 to the sixth shaft J6.

The transfer tool 1 includes a frame 18 of a strip-like shape (rectangular flat plate shape), and two sliders 19, 20 disposed on both sides in a thickness direction of the frame 18.

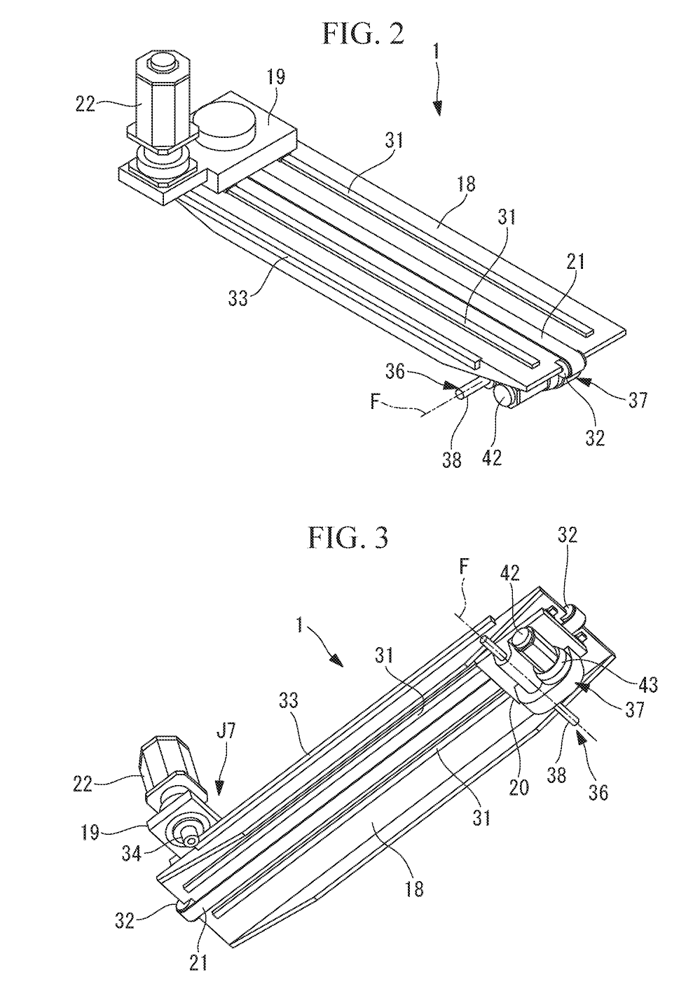

As shown in FIGS. 2 and 3, the two sliders 19, 20 are respectively supported on the front and back surfaces of the frame 18 so as to be movable in a longitudinal direction of the frame 18 along respective guide rails 31 that are disposed along the longitudinal direction of the frame 18. Also, the two sliders 19, 20 are connected with a belt 21 stretched around pulleys 32 that are supported to be rotatable around an axis parallel to both ends in the longitudinal direction of the frame 18.

A rack gear 33 is fixed to one end in the width direction of the frame 18 and laid along the longitudinal direction. As shown in FIG. 3, the rack gear 33 meshes with a pinion gear 34 of the motor 22 attached to the slider (wrist-side slider) 19. Driving the motor 22 causes the slider 19 to move to one side in the longitudinal direction on the front surface of the frame 18, which in turn causes the other slider (workpiece-side slider) 20 connected with the belt 21 to be conveyed on the belt 21 to move to the other side in the longitudinal direction on the back surface of the frame 18. That is, the two sliders 19, 20 are moved relative to each other in opposite directions along the longitudinal direction of the frame 18. This constitutes a seventh shaft (articulated shaft) J7 composed of articulated slide shafts.

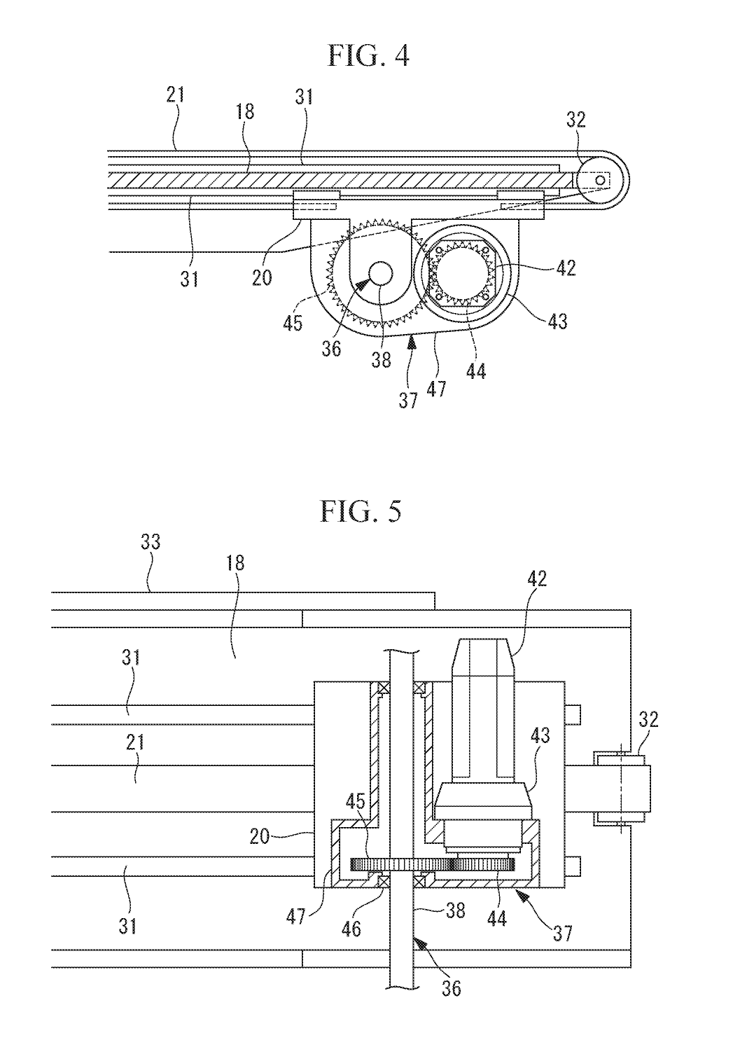

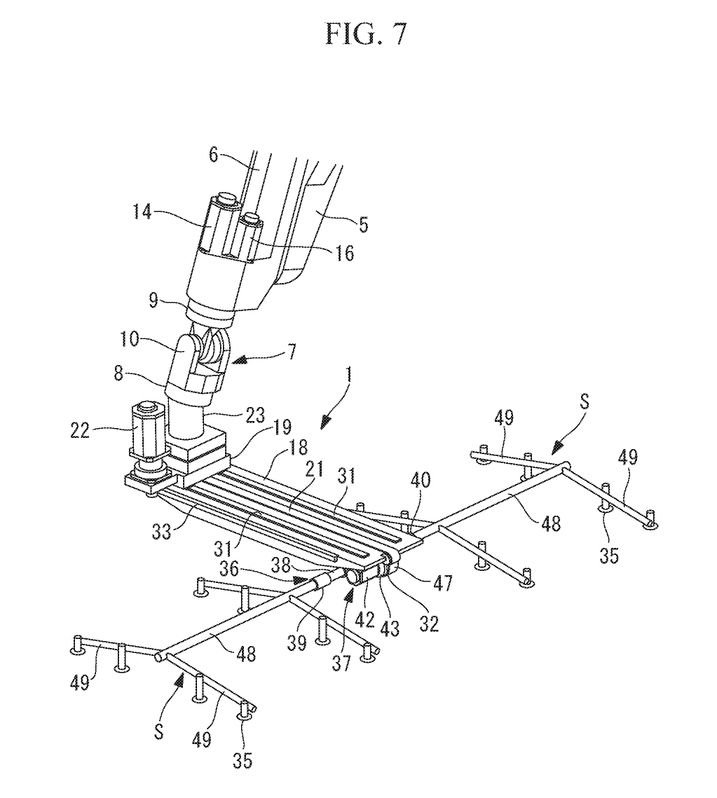

The slider 19 is fixed to the sixth shaft J6 of the wrist unit 7. As shown in FIGS. 4 and 5, the other slider 20 is provided with a workpiece support portion 36 and a distal swing shaft 37. The workpiece support portion 36 is mounted with a tool (hand) S (see FIGS. 6 and 7) that includes a plurality of vacuum pads 35 for picking up the workpiece W. The distal swing shaft 37 swings the workpiece support portion 36 around an axis F that extends in the width direction of the frame 18. The distal swing shaft 37 constitutes an eighth shaft (articulated shaft) composed of an articulated rotary shaft.

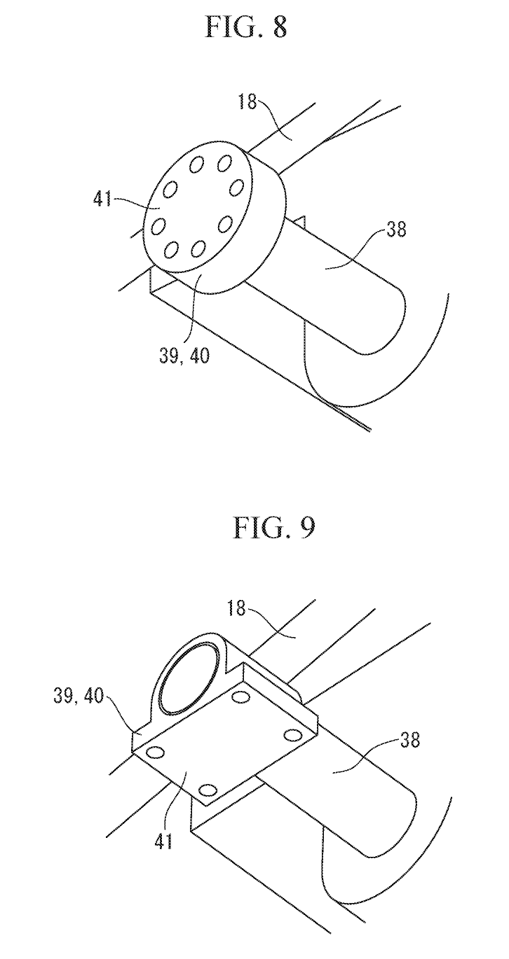

The workpiece support portion 36 includes a straight rod-shaped shaft 38 attached to the slider 20 so as to be rotatable around the axis F, and, for example, two interface portions 39, 40 fixed to respective ends of the shaft 38 as shown in FIG. 8 or 9. The two interface portions 39, 40 include mounting faces 41 that are parallel to each other. This eliminates the need for an angle adjustment of the tool S when mounting it to the interface portions 39, 40, and allows for easy mounting of the tool S.

As shown in FIGS. 4 and 5, the distal swing shaft 37 includes a motor 42, a reducer 43 that decelerates the rotation of the motor 42, and a pair of gears 44, 45 that transmits an output torque of the reducer 43 to the shaft 38. An output shaft of the reducer 43, the pair of gears 44, 45, and a bearing 46 rotatably supporting the shaft 38 are stored in a gearbox 47 and collectively lubricated.

The gearbox 47 is fixed to the slider 20, and the motor 42 is fixed to the gearbox 47 via the reducer 43. The motor 42 is disposed in parallel to the axis F of the shaft 38. The pair of gears 44, 45 is composed of, for example, a driving gear 44 that is a spur gear fixed to the output shaft of the reducer 43, and a driven gear 45 that is a spur gear fixed to the shaft 38. The driven gear 45 has a sufficiently larger diameter than that of the driving gear 44, so that rotation of the driving gear 44 is decelerated before being transmitted to the shaft 38.

As shown in FIG. 7, the tool S includes pillar portions 48 fixed to the pair of interface portions 39, 40 on respective ends of the shaft 38, and a plurality of branched portions 49 each branched and extended from the pillar portions 48. The branched portions 49 are provided with a plurality of the vacuum pads 35 oriented in the same direction.

As shown in FIG. 6, for example, the tool S picks up and releases the flat plate-shaped workpiece W with the vacuum pads 35 when supplying the workpiece W to the pressing apparatuses 24, 25 and removing the workpiece W having undergone the process by the pressing apparatuses 24, 25.

Further, as shown in FIG. 1, the robot main body 30 includes an inclination coupling member 23 that fixes the face plate 8 of the wrist unit 7 and the one slider 19 to be fixed to the face plate 8 at a predetermined inclination angle.

The inclination coupling member 23 swings the first arm 5 around the second axis B at a predetermined angle. The inclination coupling member 23 further couples the sixth shaft J6 of the wrist unit 7 with the transfer tool 1 such that the width direction and the longitudinal direction of the transfer tool 1 are substantially horizontal in the state where the wrist unit 7 is straightly oriented, namely where the fourth axis C and the sixth axis E are aligned on the same line.

The robot 100 includes, in particular, redundant articulated shafts of the first shaft J1 of the robot main body 30 and the seventh shaft J7 of the transfer tool 1 that are capable of moving the workpiece W almost in the same direction.

Then, a method for controlling the robot 100 according to the present embodiment will be explained below with reference to the drawings.

The method for controlling the robot 100 according to the present embodiment is directed to controlling the robot 100 when the robot 100 is, for example, disposed between the two pressing apparatuses 24, 25 to alternately insert and remove the workpiece W to/from the two pressing apparatuses 24, 25, as shown in FIG. 6.

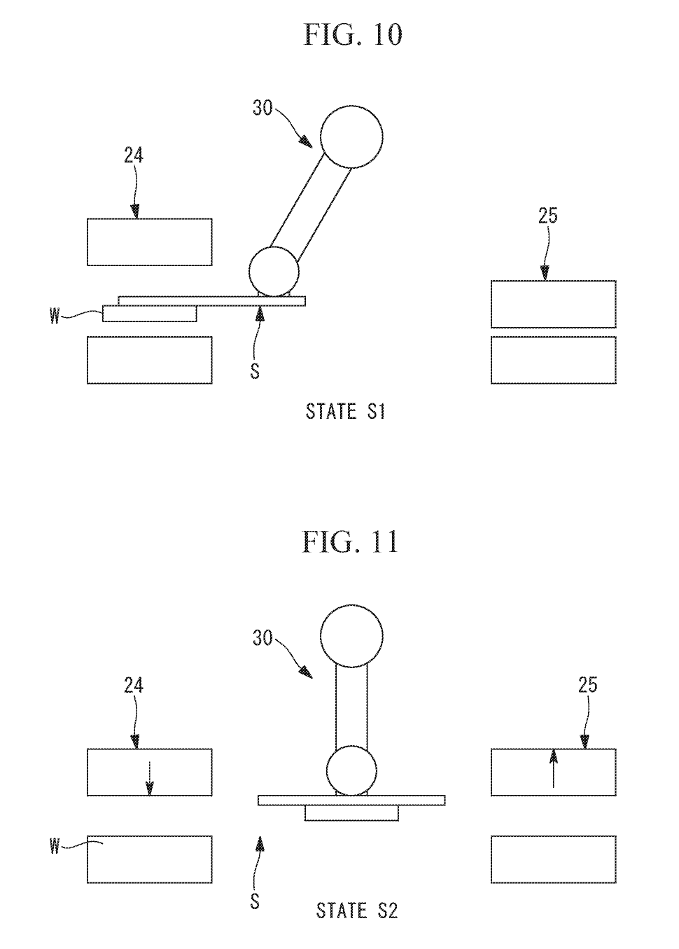

First, as shown in FIG. 10, when the first pressing apparatus 24 is open to receive the tool S after having pressed the workpiece W, the robot 100 is operated to insert the tool S into the first pressing apparatus 24 and pick up the processed workpiece W with the tool S (state S1).

Then, as shown in FIG. 11, the tool S holding the workpiece W is withdrawn from the first pressing apparatus 24 and decelerated to stand by until the second pressing apparatus 25 is open to receive the workpiece W (state S2).

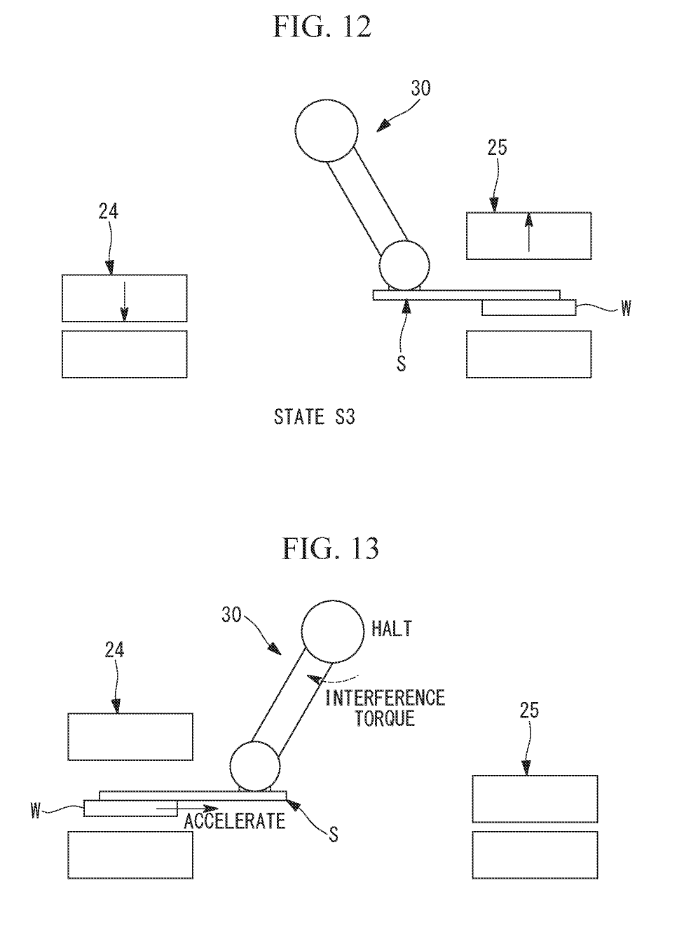

As shown in FIG. 12, when the second pressing apparatus 25 is open to receive the workpiece W, the robot 100 is operated to insert the tool S holding the workpiece W into the second pressing apparatus 25, where the workpiece W is released from holding and transferred to the second pressing apparatus 25 (state S3).

The method for controlling the robot 100 according to the present embodiment is applied to accelerating or decelerating the first shaft J1 and the seventh shaft J7 during sequential changes between the state S1, the state S2 and the state S3.

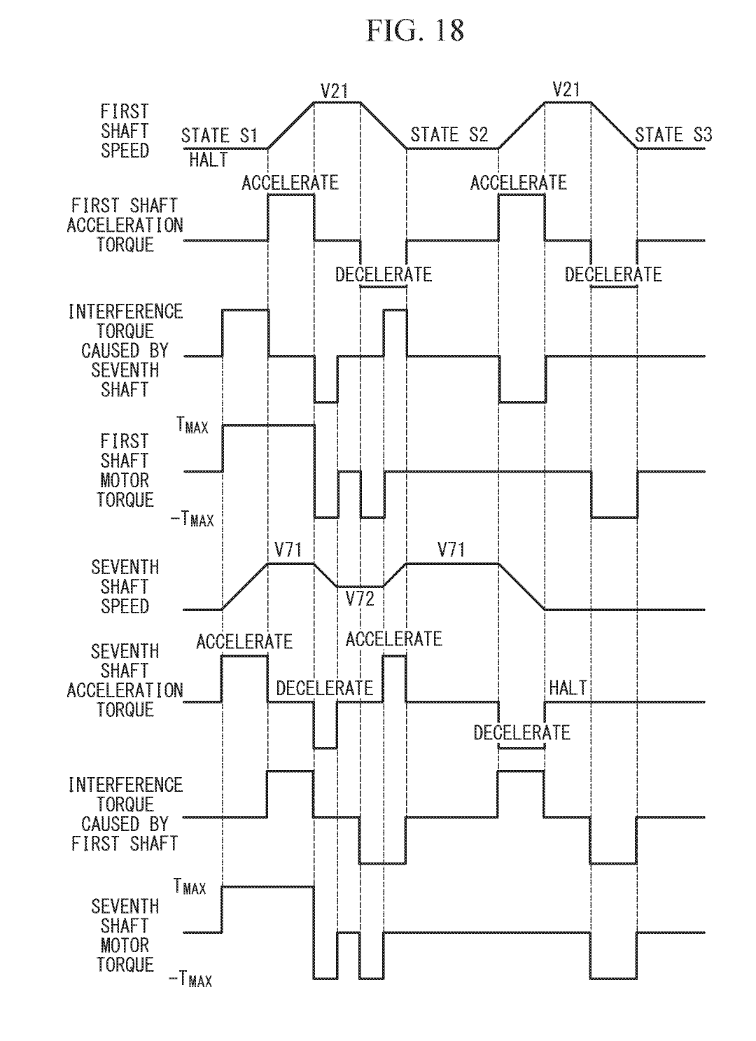

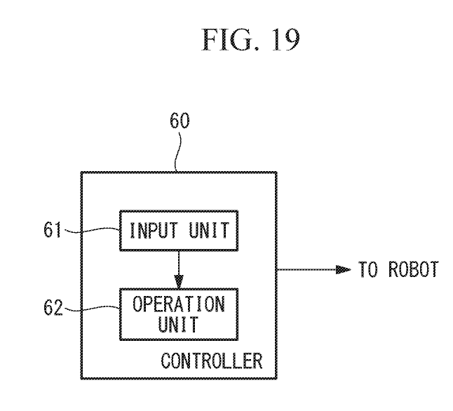

Specifically, in changing from the state S1 to the state S2, first, the seventh shaft J7 is accelerated to a predetermined first speed V71 while the first shaft J1 is halted, as shown in FIGS. 13 and 18. At this time, since the first shaft J1 is halted, the first shaft J1 is only subject to an interference torque caused by acceleration of the seventh shaft J7. Further, the first shaft J1 does not produce any interference torque acting on the seventh shaft J7.

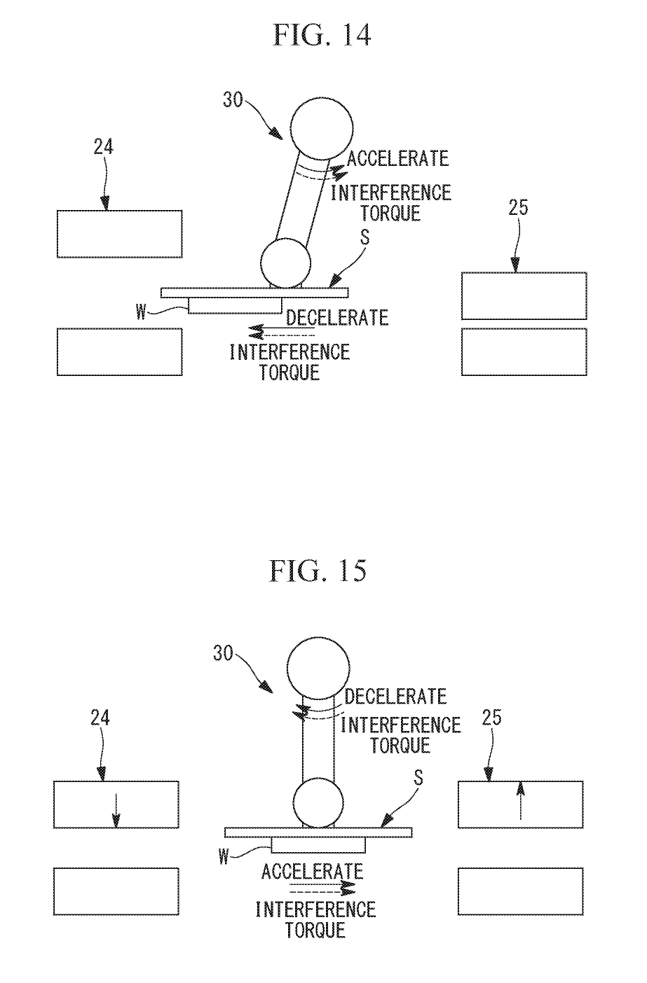

Then, as shown in FIGS. 14 and 18, the first shaft J1 is accelerated to a predetermined first speed V21 while the seventh shaft J7 is operative constantly at the first speed V71 or decelerated to a second speed V72 that is slower than the first speed V71.

At this time, while the seventh shaft J7 is operative at a constant speed, the first shaft J1 is only subject to a torque for accelerating the first shaft J1. The seventh shaft J7 is only subject to an interference torque caused by acceleration of the first shaft J1.

On the other hand, while the seventh shaft J7 is decelerated, the first shaft J1 is subject to a torque that is given by subtracting an interference torque caused by deceleration of the seventh shaft J7 from the torque for accelerating the first shaft J1. Also, the seventh shaft J7 is subject to a torque that is given by subtracting the interference torque caused by acceleration of the first shaft J1 from a torque for decelerating the seventh shaft J7.

Then, as shown in FIGS. 15 and 18, the seventh shaft J7 is accelerated to the first speed V71 while the first shaft J1 is operative constantly at the predetermined first speed V21 or decelerated to a second speed that is slower than the first speed V21 (zero speed in FIG. 18).

At this time, while the first shaft J1 is operative at a constant speed, the seventh shaft J7 is only subject to a torque for accelerating the seventh shaft J7. The first shaft J1 is only subject to the interference torque caused by acceleration of the seventh shaft J7.

On the other hand, while the first shaft J1 is decelerated, the seventh shaft J7 is subject to a torque that is given by subtracting an interference torque caused by deceleration of the first shaft J1 from the torque for accelerating the seventh shaft J7. Also, the first shaft J1 is subject to a torque that is given by subtracting the interference torque caused by acceleration of the seventh shaft J7 from a torque for decelerating the first shaft J1.

Thus, the state S1 changes to the state S2.

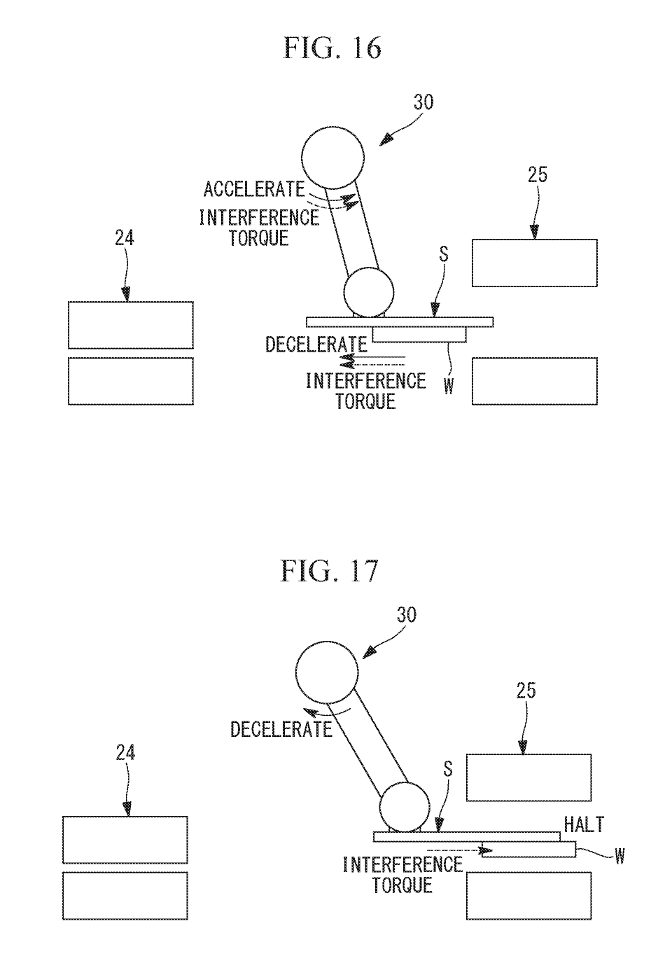

Then, as shown in FIGS. 16 and 18, the first shaft J1 is re-accelerated to the first speed V21, and the seventh shaft J7 is decelerated to zero speed. Thereafter, as shown in FIGS. 17 and 18, while the seventh shaft J7 is halted, the first shaft J1 is decelerated to result in the state S3 where the first shaft J1 is halted. At this time, since the seventh shaft J7 is decelerated while the first shaft J1 is accelerated, the first shaft J1 is subject to a torque that is given by subtracting the interference torque caused by deceleration of the seventh shaft J7 from the torque for accelerating the first shaft J1. Also, the seventh shaft J7 is subject to a torque that is given by subtracting the interference torque caused by acceleration of the first shaft J1 from the torque for decelerating the seventh shaft J7.

While the seventh shaft J7 is halted, the first shaft J1 is only subject to the torque for accelerating the first shaft J1. The seventh shaft J7 is only subject to the interference torque caused by deceleration of the first shaft J1.

That is, the method for controlling the robot 100 according to the present embodiment controls the first shaft J1 and the seventh shaft J7 in such a way that a direction of the torque generated in accelerating or decelerating one of the first shaft J1 and the seventh shaft J7 is not opposite to a direction of the interference torque acting on the other of the first shaft J1 and the seventh shaft J7. This eliminates the need for generating a larger torque than the torque T_{MAX} that is generated when each of the first shaft J1 and the seventh shaft J7 is individually accelerated or decelerated. This allows for downsizing the motors of the first shaft J1 and the seventh shaft J7 and thereby making the robot 100 smaller and lighter.

In particular, the method can control the first shaft J1 and the seventh shaft J7 in such a way that a direction of the torque generated in accelerating or decelerating one of the first shaft J1 and the seventh shaft J7 is the same as a direction of the interference torque acting on the other of the first shaft J1 and the seventh shaft J7. With this method, the first shaft J1 and the seventh shaft J7 can be accelerated or decelerated with a smaller torque than the torque T_{MAX} that is generated when each of the first shaft J1 and the seventh shaft J7 is individually accelerated or decelerated. This allows for downsizing the motors of the first shaft J1 and the seventh shaft J7 and thereby making the robot 100 smaller and lighter. This also allows for significant reduction in power consumption.

The present embodiment exemplarily describes the robot 100 that is disposed between the two pressing apparatuses 24, 25 to move the workpiece W between the pressing apparatuses 24, 25. However, the present invention is not limited to this.

Also, any other shaft structure may be used for the robot 100. In that case, the robot 100 preferably includes multiple redundant articulated shafts that are capable of moving the workpiece W in the same direction while supporting it.

Then, the controller 60 of the robot 100 according to another embodiment of the present invention will be explained below.

As shown in FIG. 19, the controller 60 according to the present embodiment includes an input unit 61 and an operation unit 62. The input unit 61 allows input of an operation program by use of a teach pendant or the like. In response to input of the operation program by the input unit 61, the operation unit 62 sets acceleration of one and another articulated shafts such that the other articulated shaft of the robot 100 is accelerated or decelerated in the same direction as a direction of the interference torque caused by acceleration or deceleration of the one articulated shaft and acting on the other articulated shaft.

In response to input of the operation program, which includes multiple teaching points and operation routes of the robot 100 between the teaching points, the controller 60 calculates acceleration patterns of each articulated shaft of the robot 100 to move the workpiece W between the teaching points according to the operation routes. In this calculation, the controller 60 configured as above automatically sets acceleration of one and another articulated shafts such that the other articulated shaft is accelerated or decelerated in the same direction as a direction of the interference torque caused by acceleration or deceleration of the one articulated shaft and acting on the other articulated shaft.

That is, when controlling, for example, the robot 100 shown in FIG. 1, the controller 60 according to the present embodiment controls the first shaft J1 and the seventh shaft J7 in such a way that a direction of the torque generated in accelerating or decelerating one of the first shaft J1 and the seventh shaft J7 of the robot 100 is not opposite to a direction of the interference torque acting on the other of the first shaft J1 and the seventh shaft J7. This eliminates the need for generating a larger torque than the torque that is generated when each of the first shaft J1 and the seventh shaft J7 is individually accelerated or decelerated. This allows for downsizing the motors of the first shaft J1 and the seventh shaft J7 and thereby making the robot 100 smaller and lighter.

The controller 60 may further include an interference torque calculation unit (not shown in the figure) that calculates an interference torque caused by acceleration or deceleration of one articulated shaft and acting on another articulated shaft, and a display (not shown in the figure) that displays the interference torque calculated by the interference torque calculation unit. For example, the display may be a teach pendant operated by a user.

From the above-described embodiment, the following invention is derived.

According to an aspect of the present invention, there is provided a method for controlling a robot having a plurality of articulated shafts capable of moving a workpiece in the same direction while supporting the workpiece. The method includes, in moving the workpiece by the robot, controlling each of the articulated shafts in such a way that an interference torque caused by acceleration or deceleration of one of the articulated shafts and acting on another one of the articulated shafts and a torque for accelerating or decelerating the other one of the articulated shafts do not act in opposite directions simultaneously.

According to the above aspect, in moving the workpiece by operating the plurality of articulated shafts of the robot supporting the workpiece, accelerating or decelerating one of the articulated shafts causes an interference torque to act on another one of the articulated shafts. The articulated shafts are controlled in such a way that a torque for accelerating or decelerating another one of the articulated shafts do not act in a direction opposite to a direction of the interference torque. This prevents the interference torque, which is caused by acceleration or deceleration of another one of the articulated shafts and acting on one of the articulated shafts, from being added to the torque for accelerating or decelerating the one of the articulated shafts.

That is, if an acceleration direction of one articulated shaft and a direction of an interference torque caused by another articulated shaft and acting on the one articulated shaft are opposite to each other, a large motor is required to generate a large torque that is the sum of a torque required to accelerate or decelerate the one articulated shaft individually and the additional interference torque. The method for controlling the robot according to the aspect controls the articulated shafts in such a way that an acceleration direction of one articulated shaft and a direction of an interference torque caused by another articulated shaft and acting on the one articulated shaft are not simultaneously opposite to each other. With this method, a motor for driving the one articulated shaft can be a small one that is capable of generating a torque required to accelerate or decelerate the one articulated shaft individually. This allows for downsizing the motor, making the robot smaller and lighter and reducing power consumption.

In the above aspect, the other one of the articulated shafts may be accelerated or decelerated in the same direction as a direction of the interference torque caused by acceleration or deceleration of the one of the articulated shafts and acting on the other one of the articulated shafts.

With this configuration, the other one of the articulated shafts is accelerated or decelerated in the same direction as a direction of the interference torque caused by acceleration or deceleration of the one of the articulated shafts and acting on the other one of the articulated shafts. This allows the interference torque, which is caused by acceleration or deceleration of the other one of the articulated shafts and acting on the one of the articulated shafts, to act in the same direction as the acceleration direction of the one of the articulated shafts.

That is, the method for controlling the robot according to the above aspect sets acceleration such that an acceleration direction of one articulated shaft and a direction of an interference torque caused by another articulated shaft and acting on the one articulated shaft are in the same direction. Thus, a motor for driving the one articulated shaft can be a small one that is capable of generating a small torque given by subtracting the interference torque from a torque required to accelerate or decelerate the one articulated shaft individually. This allows for downsizing the motor, making the robot smaller and lighter and reducing power consumption.

In the above aspect, the robot may be disposed between two pressing apparatuses, and each of the articulated shafts may be accelerated or decelerated when a hand for picking up and releasing the workpiece is inserted into or withdrawn from each of the pressing apparatuses.

The articulated shafts of the robot are simultaneously accelerated or decelerated when the robot is operated to insert the workpiece supported on the hand into the pressing apparatus, to withdraw the hand from the pressing apparatus after transferring the workpiece on the pressing apparatus, to insert the hand into the pressing apparatus to pick up, from the pressing apparatus, the workpiece having undergone press work by the pressing apparatus, or to withdraw the hand supporting the workpiece from the pressing apparatus.

During these operations, the robot is frequently accelerated or decelerated to synchronize with the pressing apparatus. This acceleration or deceleration of the robot is controlled such that an acceleration direction of one articulated shaft and a direction of an interference torque caused by another articulated shaft and acting on the one articulated shaft are in the same direction. This can reduce a torque generated by the motor of each articulated shaft, which in turn allows for downsizing the motor, making the robot smaller and lighter and reducing power consumption.

In the above aspect, the robot may have a redundant degree of freedom for placing the workpiece at a predetermined position and orientation.

With this configuration, operating directions of the articulated shafts to move the workpiece in the same direction coincide with each other. In simultaneously operating the articulated shafts having this relationship, the articulated shafts are controlled such that an acceleration direction of one articulated shaft and a direction of an interference torque caused by another articulated shaft and acting on the one articulated shaft are in the same direction. This can reduce a torque generated by the motor of each articulated shaft, which in turn allows for downsizing the motor, making the robot smaller and lighter and reducing power consumption.

According to another aspect of the present invention, there is provided a controller of a robot having a plurality of articulated shafts capable of moving a workpiece in the same direction while supporting the workpiece. In response to input of an operation program to move the workpiece by the robot, the controller sets acceleration of one and another of the articulated shafts in such a way that the other one of the articulated shafts is accelerated or decelerated in the same direction as a direction of an interference torque caused by acceleration or deceleration of the one of the articulated shafts and acting on the other one of the articulated shafts.

In the above aspect, the controller may include an interference torque calculation unit configured to calculate the interference torque caused by acceleration or deceleration of the one of the articulated shafts and acting on the other one of the articulated shafts; and a display configured to display the interference torque calculated by the interference torque calculation unit.

### REFERENCE SIGNS LIST

24, 25 Pressing apparatus
Controller
100 Robot
J1, J2, J3, J4, J5, J6, J7 Articulated shaft
S Tool (hand)
W Workpiece

1. A method for controlling a robot, the robot having a plurality of articulated shafts capable of moving a workpiece in a same direction while supporting the workpiece, the method comprising:
in moving the workpiece by the robot, controlling each of the articulated shafts in such a way that an interference torque caused by acceleration or deceleration of one of the articulated shafts and acting on another one of the articulated shafts and a torque for accelerating or decelerating the other one of the articulated shafts do not act in opposite directions simultaneously.

2. The method for controlling the robot according to claim 1, wherein the other one of the articulated shafts is accelerated or decelerated in a same direction as a direction of the interference torque caused by acceleration or deceleration of the one of the articulated shafts and acting on the other one of the articulated shafts.

3. The method for controlling the robot according to claim 1, wherein the robot is disposed between two pressing apparatuses, and
each of the articulated shafts is accelerated or decelerated when a hand for picking up and releasing the workpiece is inserted into or withdrawn from each of the pressing apparatuses.

4. The method for controlling the robot according to claim 1, wherein the robot has a redundant degree of freedom for placing the workpiece at a predetermined position and orientation.

5. A controller of a robot, the robot having a plurality of articulated shafts capable of moving a workpiece in a same direction while supporting the workpiece, wherein
in response to input of an operation program to move the workpiece by the robot, the controller sets acceleration of one and another of the articulated shafts in such a way that the other one of the articulated shafts is accelerated or decelerated in a same direction as a direction of an interference torque caused by acceleration or deceleration of the one of the articulated shafts and acting on the other one of the articulated shafts.

6. The controller of the robot according to claim 5, the controller comprising:
an interference torque calculation unit configured to calculate the interference torque caused by acceleration or deceleration of the one of the articulated shafts and acting on the other one of the articulated shafts; and
a display configured to display the interference torque calculated by the interference torque calculation unit.
